(19) United States
(12) Patent Application Publication
(10) Pub. No.: US 2025/0321727 A1
(43) Pub. Date: Oct. 16, 2025

(54) BALANCED CONTROL-TREATMENT EXPERIMENTS FOR SOFTWARE TESTING

(71) Applicant: Google LLC, Mountain View, CA (US)

(72) Inventors: Scott Williams, Mountain View, CA (US); Haifeng Ji, Palo Alto, CA (US)

(21) Appl. No.: 18/865,306

(22) PCT Filed: May 26, 2022
(86) PCT No.: PCT/US2022/072585

§ 371 Date: Nov. 12, 2024

(51) Int. Cl. G06F 8/65; G06F 11/34; G06F 11/3604

(52) U.S. Cl. CPC G06F 8/65; G06F 11/3409; G06F 11/3612

(57) ABSTRACT

A computing system may determine that a software application installed at a computing device in a control group associated with a control-treatment experiment for the software application is a control version of the software application. The computing system may determine. based at least in part on the computing device being in the control group and the software application installed at the computing device being the control version of the software application. a software update for updating the software application to be sent to the computing device. The computing system may send. to the computing device. the software update to trigger the computing device to. in response to receiving the software update. reinstall the control version of the software application at the computing device from a storage device of the computing device.

### BACKGROUND

A software developer may perform control-treatment experiments (i.e., A/B testing) to evaluate whether performance issues experienced during downloading, installing, and/or execution of a new version of a software application were introduced by the new version of the software application. The software developer may collect performance data for the new version of the software application and performance data for an older version of the software application, and may use the collected performance data to identify performance issues introduced by the new version of the software application.

### SUMMARY

In general, the techniques of this disclosure are directed to performing control-treatment experiments for a software application in ways that improves the performance of such experiments. A computing system may deploy a treatment version of a software application at computing devices in a treatment group, and the performance of the treatment version of the software application can be compared against the performance of a control version of the software application installed at computing devices in the control group.

The computing system may collect performance data regarding the downloading and installation of the treatment version of the software application at computing devices. In order to generate corresponding performance data from computing devices in the control group, the computing device may send, to computing devices in the control group that have installed the control version of the software application, the treatment version of the software application. The computing devices in the control group may, in response to receiving the treatment version of the software application, reinstall the control version of the software application.

Because the computing devices in the control group and the computing devices in the treatment group may both download the treatment version of the software application, the techniques of this disclosure may reduce any bias in comparing the performance data regarding the computing devices in the control group and the performance data regarding the computing devices in the treatment group that may be introduced by the computing devices in the control group and the computing devices in the treatment group downloading different data having very different characteristics (e.g., different download sizes). Furthermore, by causing the computing devices in the control group to re-install the control version of the software application, the techniques of this disclosure may trigger the computing devices to perform an installation action, thereby enabling the performance data regarding the installation of the treatment version of the software application at computing devices in the treatment group to be compared against corresponding performance data regarding the re-installation of the control version of the software application at computing devices in the control group. In this way, the techniques of this disclosure improve the technical field of software testing.

Further, because computing devices in the control group download the treatment version of the software application, when the treatment version of the software application becomes the new release version of the software application, the computing devices in the control group may not have to re-download the treatment version of the software application to upgrade to the new release version of the software application. In this way, the techniques of this disclosure may also reduce network usage by the computing devices in the control group, thereby potentially providing further technical improvements.

In some aspects, the techniques described herein relate to a method including: determining, by one or more processors of a computing system, that a software application installed at a computing device in a control group associated with a control-treatment experiment for the software application is a control version of the software application; determining, by the one or more processors and based at least in part on the computing device being in the control group and the software application installed at the computing device being the control version of the software application, a software update for updating the software application to a treatment version of the software application that is to be sent to the computing device; and sending, by the one or more processors to the computing device, the software update to trigger the computing device to, in response to receiving the software update, reinstall the control version of the software application at the computing device from a storage device of the computing device.

In some aspects, the techniques described herein relate to a computing system including: a memory that stores instructions; and one or more processors that executes the instructions to: determine that a software application installed at a computing device in a control group associated with a control-treatment experiment for the software application is a control version of the software application; determine, based at least in part on the computing device being in the control group and the software application installed at the computing device being the control version of the software application, a software update for updating the software application to a treatment version of the software application that is to be sent to the computing device; and send, to the computing device, the software update to trigger the computing device to, in response to receiving the software update, reinstall the control version of the software application at the computing device from a storage device of the computing device.

In some aspects, the techniques described herein relate to a non-transitory computer-readable storage medium comprising instructions that, when executed by one or more processors, cause the one or more processors of a computing system to: determine that a software application installed at a computing device in a control group associated with a control-treatment experiment for the software application is a control version of the software application; determine, based at least in part on the computing device being in the control group and the software application installed at the computing device being the control version of the software application, a software update for updating the software application to a treatment version of the software application that is to be sent to the computing device; and send, to the computing device, the software update to trigger the computing device to, in response to receiving the software update, reinstall the control version of the software application at the computing device from a storage device of the computing device.

In some aspects, the techniques described herein relate to an apparatus including: means for determining that a software application installed at a computing device in a control group associated with a control-treatment experiment for the software application is a control version of the software application; means for determining, based at least in part on the computing device being in the control group and the software application installed at the computing device being the control version of the software application, a software update for updating the software application to a treatment version of the software application that is to be sent to the computing device; and means for sending, to the computing device, the software update to trigger the computing device to, in response to receiving the software update, reinstall the control version of the software application at the computing device from a storage device of the computing device.

In some aspects, the techniques described herein relate to a method including: receiving, by one or more processors of a computing device and from a computing system, a software update for updating a software application, wherein the computing device is in a control group associated with a control-treatment experiment for the software application, and wherein a control version of the software application is installed at the computing device; determining, by the one or more processors, whether the software update is for updating the software application to a treatment version of the software application; and responsive to determining that the software update is for updating the software application to the treatment version of the software application, re-installing, by the one or more processors, the control version of the software application at the computing device from a storage device of the computing device.

In some aspects, the techniques described herein relate to a computing system including: a memory that stores instructions; a storage device; and one or more processors that executes the instructions to: receive, from a computing system, a software update for updating a software application, wherein the computing device is in a control group associated with a control-treatment experiment for the software application, and wherein a control version of the software application is installed at the computing device; determine whether the software update is for updating the software application to a treatment version of the software application; and responsive to determining that the software update is for updating the software application to the treatment version of the software application, re-install the control version of the software application at the computing device from the storage device of the computing device.

In some aspects, the techniques described herein relate to a non-transitory computer-readable storage medium comprising instructions that, when executed by one or more processors, cause the one or more processors of a computing device to receive, from a computing system, a software update for updating a software application, wherein the computing device is in a control group associated with a control-treatment experiment for the software application, and wherein a control version of the software application is installed at the computing device; determine whether the software update is for updating the software application to a treatment version of the software application; and responsive to determining that the software update is for updating the software application to the treatment version of the software application, re-install the control version of the software application at the computing device from a storage device of the computing device.

In some aspects, the techniques described herein relate to an apparatus including: means for receiving, from a computing system, a software update for updating a software application, wherein the computing device is in a control group associated with a control-treatment experiment for the software application, and wherein a control version of the software application is installed at the computing device; means for determining whether the software update is for updating the software application to a treatment version of the software application; and means for, responsive to determining that the software update is for updating the software application to the treatment version of the software application, re-installing the control version of the software application at the computing device from a storage device of the computing device.

The details of one or more examples are set forth in the accompanying drawings and the description below. Other features, objects, and advantages of the disclosure will be apparent from the description and drawings, and from the claims.

### BRIEF DESCRIPTION OF DRAWINGS

FIG. 1 is a conceptual diagram illustrating an example environment for software testing, in accordance with one or more aspects of the present disclosure.

FIG. 2 is a block diagram illustrating further details of an example computing device, in accordance with one or more aspects of the present disclosure.

FIG. 3 is a block diagram illustrating an example computing system, in accordance with one or more aspects of the present disclosure.

FIGS. 4A-4B are block diagrams illustrating software testing, in accordance with aspects of this disclosure.

FIG. 5 is a flowchart illustrating example operations performed by an example computing system that is configured to perform software testing, in accordance with one or more aspects of the present disclosure.

FIG. 6 is a flowchart illustrating example operations performed by an example computing device that is in a control group for a control-treatment experiment to test a software application, in accordance with one or more aspects of the present disclosure.

### DETAILED DESCRIPTION

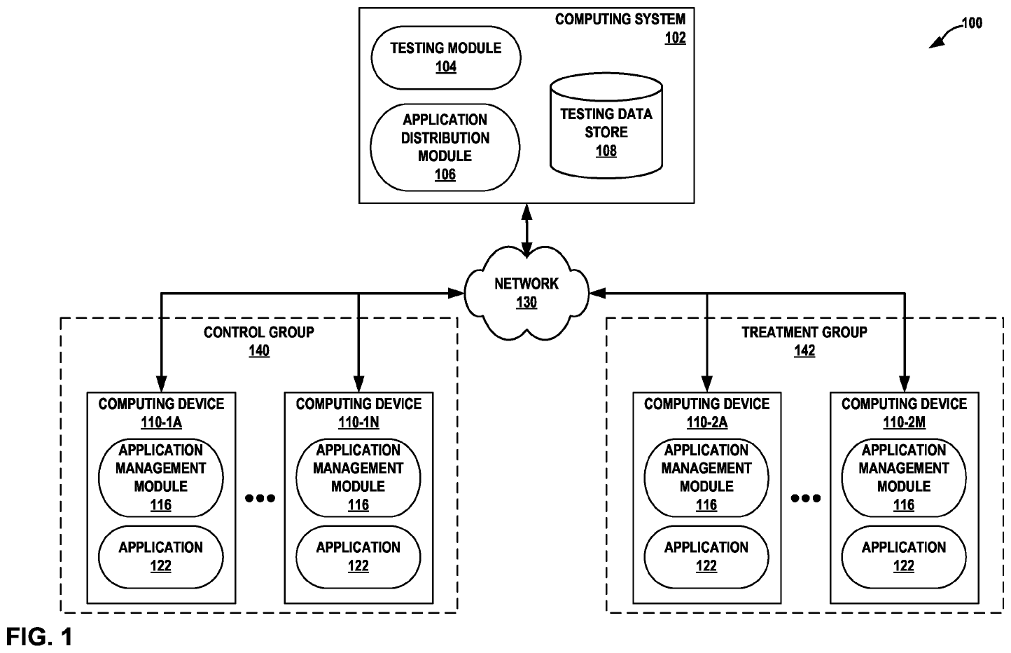

FIG. 1 is a conceptual diagram illustrating an example environment for software testing, in accordance with one or more aspects of the present disclosure. In the example of FIG. 1, environment 100 may include computing system 102 that communicates with computing devices 110-1A to 110-1N and computing devices 110-2A to 110-2N (collectively “computing devices 110”) via network 130.

Computing system 102 may represent any suitable computing system, such as one or more desktop computers, laptop computers, mainframes, servers, cloud computing systems, etc. capable of sending and receiving information both to and from a network, such as network 130. In some examples, computing system 102 may represent cloud computing systems that provide access to their respective services via a cloud.

Computing system 102 includes testing module 104, application distribution module 106, and testing data store 108. Testing module 104 and application distribution module 106 may perform operations described herein using software, hardware, firmware, or a mixture of hardware, software, and firmware residing in and/or executing at computing system 102. Computing system 102 may execute testing module 104 and application distribution module 106 with multiple processors or multiple devices, as virtual machines executing on underlying hardware, as one or more services of an operating system or computing platform, and/or as one or more executable programs at an application layer of a computing platform of computing system 102.

Testing module 104 may perform functions associated with performing control-treatment experiments (i.e., A/B testing) for software applications installed at computing devices 110. In some examples, testing module 104 may be included in the operating system of computing system 102.

Application distribution module 106 may perform functions associated with distribution of software applications and/or software updates to computing devices 110. For example, application distribution module 106 may send, to computing devices 110, software updates for updating software applications (e.g., software application 122). Furthermore, application distribution module 106 may handle requests from computing devices 110 to auto update and/or manually update software applications by sending updates to software applications to computing devices 110. In some examples, application distribution module 106 may be included in the operating system of computing system 102.

Testing data store 108 may be any suitable data store, such as a database, a repository, and the like for storing data associated with the performance of control-treatment experiments for software applications. For example, testing data store 108 may store indications of versions of software application 122 installed at each of computing devices 110, the testing state of the control-treatment experiment, indications of the treatment version of software application 122, indications of the control version of software application 122, and the like.

Network 130 represents any public or private communications network, for instance, cellular, Wi-Fi, and/or other types of networks, for transmitting data between computing systems, servers, and computing devices. Network 130 may include one or more network hubs, network switches, network routers, or any other network equipment, that are operatively inter-coupled thereby providing for the exchange of information between computing system 102 and computing devices 110. Computing devices 110 and computing system 102 may transmit and receive data across network 130 using any suitable communication techniques. Each of computing system 102 and computing devices 110 be operatively coupled to network 130 using respective network links, such as Ethernet, Wi-Fi, or any other types of wired and/or wireless network connections.

Computing devices 110 each represents an individual mobile or non-mobile computing device. Examples of each of computing devices 110 include a mobile phone, a tablet computer, a laptop computer, a desktop computer, a server, a mainframe, a set-top box, a television, a wearable device (e.g., a computerized watch, computerized eyewear, computerized headphones, computerized gloves, etc.), a home automation device or system (e.g., an intelligent thermostat or home assistant device), a personal digital assistant (PDA), a gaming system, a media player, an e-book reader, a mobile television platform, an automobile navigation or infotainment system, or any other type of mobile, non-mobile, wearable, and non-wearable computing device.

Each of computing devices 110 includes application management module 116 and software application 122. Application management module 116 and software application 112 may perform operations described herein using software, hardware, firmware, or a mixture of hardware, software, and firmware residing in and/or executing at computing device 110-1A. Each of computing devices 110 may execute application management module 116 and software application 112 with multiple processors or multiple devices, as virtual machines executing on underlying hardware, as one or more services of an operating system or computing platform, and/or as one or more executable programs at an application layer of a computing platform of each of computing devices 110.

Software application 122 may be any software application executable by computing devices 110 to perform one or more functions. In some examples, software application 122 may be a first-party application provided by the operating system or provided by the manufacturer of computing devices 110. In some examples, software application 122 may be an application provided by a third-party developer.

Application management module 116 may perform functions associated with managing of software applications, including software application 122, installed at computing devices 110. For example, application management module 116 may download (e.g., from computing system 102) and install software applications, re-install applications already installed at computing devices 110, perform manual and/or automatic updating of software applications, and the like. In some examples, application management module 116 may be included in the operating system of computing devices 110 or may be a part of an app store application at computing devices 110.

In the example of FIG. 1, a developer may use environment 100 to perform control-treatment experiments (i.e., A/B testing) to test versions of a software application (e.g., software application 122) before such versions of the software application are potentially released. A developer may perform such a control-treatment experiment to evaluate whether performance issues experienced during downloading, installing, and/or execution of a version of the software application were introduced by the version of software application.

A developer of a software application may periodically release new versions of a software application to provide new features, fix bugs in previous versions of the software application, and the like. However, the new version of the software application may, in some instances cause issues that may negatively impact the performance of computing devices that have installed the new version of the software application. For example, computing devices may fail to successfully download and/or install the new version of the software application, the new version of the software application may suffer from a slower startup speed, the new version of the software application may crash while in use, the new version of the software application may introduce new bugs, and the like.

The developer of the software application may perform control-treatment experiments on a version of the software application to evaluate whether performance issues experienced during downloading, installing, and/or execution that version of the software application were introduced by the version of the software application. To perform such experiments, a developer may perform a controlled release of the new version of the software application to roll out the new version of the software application to a limited number of computing devices. That is, the developer may release the new version of the software application to fewer than all of computing devices on which the software application is installed.

By performing a controlled release of the new version of the software application, the developer may separate the computing devices on which the software application is installed into two groups of the same or very similar size: a treatment group that includes computing devices on which the new version of the software application is installed and a control group that includes computing devices on which an older version of the software application is installed. In the context of control-treatment experiments, the new version of the software application being tested is referred to as the treatment version of the software application. Further, the control group may include computing devices on which the same older version of the software application is installed, and that older version of the software application is referred to herein as the control version of the software application in the context of control-treatment experiments.

The developer of the software application may collect performance data associated with the software application from both the computing devices in the treatment group on which the treatment version of the software application is installed as well as the computing devices in the control group on which the control version of the software application is installed. Such performance data may include the download failure rate, the installation failure rate, application crash rate, application startup latency, power usage, memory usage, frame rate metrics, or any other suitable performance data and/or metric. The developer may compare the performance data collected from the computing devices in the treatment group with the performance data collected from the computing devices in the control group to compare the performance issues associated with the treatment version of the computing device with the performance issues associated with the control version of the software application. In this way, the developer is able to determine performance issues associated with the new version of the software application and to evaluate whether such performance issues were introduced by the new version of the software application.

Performance issues associated with the release of a new version of the software application may arise not just during startup or during execution of the software application. Instead, the release of a new version of the software application may sometimes introduce performance issues during download and installation of the software application. As such, a developer may also collect performance data associated with the download and installation of the treatment version of the software application by computing devices in the treatment group.

In order to compare performance data associated with the download and installation of the treatment version of the software application at computing devices in the treatment group with corresponding data generated from computing devices in the treatment group, the developer may generate a placebo version of the software application, and computing devices in the control group may download and install the placebo version of the software application, which may then become the control version of the software application. The developer is therefore able to collect performance data associated with the download and installation of the placebo version of the software application by computing devices in the control group for comparison with the performance data associated with download and installation of the treatment version of the software application by computing devices in the treatment group.

However, using such placebo versions of the software application in order to generate performance data for the control group to be compared against the performance data for the treatment group may cause certain technical issues. For example, computing devices may not be aware that the placebo version of the software application is an upgrade, and thus may fail to install the placebo version of the software application. This may require the developer to create builds of placebo versions of the software application with very specific version codes in order for computing devices to be aware that the placebo version of the software application is an upgrade.

Further, failing to upgrade to the placebo version of the software application may cause the computing devices in the control group to run different versions of the software application, thereby creating an imbalance between the number of computing devices running the treatment versions of the software application and the number of computing devices running the placebo version of the software application in the control group. Such an imbalance, also referred to arm imbalance, may possibly skew comparisons of performance data between the treatment group and the control group.

In addition, a software update for updating the software application to a placebo version of the software application may be of a different size than a software update for updating the software application to a treatment version of the software application. The different sizes of the software updates may introduce variances in the download and installation performance of the placebo version of the software application versus the treatment version of the software application, thereby possibly skewing or biasing comparisons of the performance data associated with the download and installation of the placebo version of the software application and the performance data associated with the download and installation of the treatment version of the software application.

In accordance with aspects of the present disclosure, a computing system may, when performing control-treatment experiments for a software application, use a version of the software application as a placebo in order to compare the performance data associated with the control group and the performance data associated with the treatment group. That is, the computing system may, along with deploying a treatment version of a software application to computing devices in the treatment group, also send, to computing devices in the control group, a version of the software application, in order to collect and compare performance data regarding the treatment version of the software application deployed at the treatment group and the control version of the software application deployed at the control group. Specifically, a computing system may determine, for a computing device in the control group, the version of the software application installed at the computing device. If the computing system determines that the version of the software application installed at the computing device is the control version of the software application, the computing system may send, to the computing device, the treatment version of the computing device to trigger the computing device to re-install the control version of the computing device. The computing device may, in response to receiving the treatment version of the software application, re-install the control version of the software application from a storage device of the computing device.

Because the computing devices in the control group and the computing devices in the treatment group may both download the treatment version of the software application, the techniques of this disclosure may reduce any bias in comparing the performance data regarding the computing devices in the control group and the performance data regarding the computing devices in the treatment group that may be introduced by the computing devices in the control group and the computing devices in the treatment group downloading different data having very different characteristics (e.g., different download sizes). Furthermore, by causing the computing devices in the control group to re-install the control version of the software application, the techniques of this disclosure may trigger the computing devices to perform an installation action, thereby enabling the performance data regarding the installation of the treatment version of the software application at computing devices in the treatment group to be compared against corresponding performance data regarding the re-installation of the control version of the software application at computing devices in the control group. In this way, the techniques of this disclosure improves the technical field of software testing.

Similarly, if the computing system determines that the version of the software application installed at the computing device is not the control version of the software application, the computing system may send, to the computing device, the control version of the computing device to trigger the computing device to install the control version of the computing device. The computing device may, in response to receiving the control version of the software application, install the control version of the software application. By sending and installing the control version of the software application to computing devices in the control group that have not installed the control version of the software application. In this way, the techniques of this disclosure may increase the number of computing devices in the control group on which the control version of the software application is installed, thereby improving security of the computing devices in the control group by increasing the number of computing devices that are upgraded from older versions of the software application to the control version of the software application. Further, increasing the number of computing devices in the control group on which the control version of the software application is installed may reduce the difference between the number of computing devices in the treatment group on which the treatment version of the software application installed, and the number of computing devices in the control group on which the control version of the software application installed, thereby improving the technical field of software testing.

In the example of FIG. 1, in order to perform such testing of software application 122, the developer may divide computing devices 110 with which to perform such testing into two groups: control group 140 and treatment group 142. Computing devices 110-1A to 110-1N (“computing devices 110-1”) are included in control group 140, while computing devices 110-2A to 110-2M (“computing devices 110-2”) are included in treatment group 142.

Computing devices 110-2 in treatment group 142 are computing devices that are to receive and install new versions of software application 122 for testing, while computing devices 110-1 in control group 140 may execute a control version of software application 122. The developer may compare performance data associated with the new versions of software application 122 collected from computing devices 110-2 in treatment group 142 with performance data associated with the control version of software application 122 collected from computing devices 110-1 in control group 140 to determine performance issues associated with new versions of software application 122 and to evaluate whether such performance issues were introduced by new versions of software application 122.

The developer may select computing devices 110-1 to be included in control group 140 out of computing devices 110 and computing devices 110-2 to be included in treatment group 142 out of computing devices 110 in any manner. In some examples, the developer may select computing devices 110-1 to be included in control group 140 and computing devices 110-2 to be included in treatment group 142 so that control group 140 and treatment group 142 include the same number of computing devices.

In some examples, computing system 102 may use one or more heuristics, such as implemented by one or more neural networks, to select computing devices 110-1 to be included in control group 140 out of computing devices 110 and computing devices 110-2 to be included in treatment group 142 out of computing devices 110. The one or more neural networks may be implemented by computing system 102 or may be implemented by a remote computing system in communication with computing system 102.

In general, one or more neural networks may include multiple interconnected nodes, and each node may apply one or more functions to a set of input values that correspond to one or more features, and provide one or more corresponding output values. In the context of selecting computing devices 110 to be included in control group 140 and/or treatment group 142, the one or more features may include usage data of software application 122 at computing devices 110, usage data of computing devices 110, performance data collected from computing devices 110 during previous control-treatment experiments, and/or any other data regarding computing devices 110, the one or more corresponding output values of one or more neural networks may be an indication, for each of computing devices 110, of whether the computing device is included in control group 140, whether the computing device is included in treatment group 142, or whether the computing device is not to be included in either control group 140 or treatment group 142.

Computing system 102 may determine the control version of software application 122 for the control-treatment experiment in any fashion. In general, the control version of software application 122 and the treatment version of software application 122 may be the same version or newer than the versions of software application 122 installed at computing devices 110. In some examples, computing system may determine the control version of software application 122 as a version of software application 122 that is fully released to computing devices (e.g., the most-installed version of software application 122 at computing devices 110) or a most recent version of software application 122 prior to the new version of software application 122 that is being tested. In some examples, the control version of software application 122 may be a developer-created version of software application 122 that is most similar in size, or includes the same modules, as the new version of software application 122.

To test a new version of software application 122, the developer may deploy the new version of software application 122 at each of computing devices 110-2 in treatment group 142. In control-treatment experiments, the new version of software application 122 that is being tested is referred to as a treatment version of software application 122. The developer may use computing system 102 to send the treatment version of software application 122 to each of computing devices 110-2 in treatment group 142, and each of computing devices 110-2 in treatment group 142 may receive and install the treatment version of software application 122, such as by using application management module 116 to receive and install a software upgrade to upgrade software application 122 installed at computing devices 110-2 to the treatment version of software application 122.

Computing system 102 may send the treatment version of software application 122 to computing devices 110 in any form. For example, computing system 102 may send, to computing devices 110-2 in treatment group 142, a software update to update software application 122 to the treatment version of software application 122. The software update may include a package, an archive file, or any other technique for bundling code and resources, and may be compressed or uncompressed.

In some examples, a software update may include code and data to install the treatment version of software application 122 in place of the currently installed version of software application 122. That is, application management module 116 may, in response to receiving the software update, replace the currently installed version of software application 122 with the treatment version of software application 122.

In some examples, a software update may include code and data to patch the currently installed version of software application 122 to upgrade software application 122 to the treatment version of software application 122. That is, application management module 116 may, in response to receiving the software update, patch the currently installed version of software application 122 to update the currently installed version of software application 122 to the treatment version of software application 122.

In some examples, a software update may include modular updates to software application 122. Such modular updates may update specific features and functionality of software application 122, referred to herein as modules, to the treatment version of such features and functionality. A software update for updating one or more modules of software application 122 may include code and data to install the treatment version of the one or more modules in a currently installed version of software application 122, and/or may include code and data to patch the one or more modules in a currently installed version of software application 122 to update those one or more modules in software application 122 to the treatment version of the one or more modules.

As part of testing a treatment version of software application 122, computing system 102 may also send data to computing devices 110-1 in control group 140. Sending data to computing devices 110-1 in control group 140 may act as a placebo that corresponds to the treatment version of software application 122, and may enable the developer to properly evaluate the performance of downloading and installing the treatment version of software application by computing devices in treatment group 142 against the download and installation of data by computing devices in control group 140.

In accordance with aspects of the disclosure, during a control-treatment experiment for software application 122, testing module 104 of computing system 102 may, for a computing device from computing devices 110-1 in control group 140, determine the version of software application 122 currently installed at the computing device. Testing module 104 may determine, based on the currently installed version of software application 122 at the computing device, a version of software application 122 to send to the computing device. Application distribution module 106 may therefore send the determined version of software application 122 to the computing device.

Sending a version of software application 122 to computing devices 110-1 in control group 140 may enable a developer of software application 122 to compare the performance of computing devices 110-2 in treatment group 142 when downloading and installing the treatment version of software application 122 against the performance of computing device 110-1 in control group 140 when downloading and installing versions of software application 122. That is, during the control-treatment experiment, when computing system 102 receives a request to update software application 122 from a computing device in control group 140, such as an auto update request or a manual update request, computing system 102 may, in response, send a version of software application 122 to the requesting computing device, and the developer may collect performance data regarding the download of the software application 122.

In some examples, computing system 102 may send the treatment version of software application 122 to computing devices 110-1 in control group 140 that have already installed the control version of software application 122 to trigger those computing devices to re-install the control version of software application 122 from a storage device of the computing devices. That is, when computing system 102 determines that a computing device in control group 140 has already installed the control version of software application 122, computing system 102 may determine that the control version of software application 122 should remain installed at the computing device.

As such, computing system 102 may, in response to determining that the control version of software application 122 is installed at a computing device in control group 140, send the treatment version of software application 122 to the computing device, which causes the computing device to re-install the control version of software application 122 from a storage device of the computing devices. Triggering re-installation of the control version of software application 122 may therefore enable the developer of software application 122 to collect performance data regarding the installation of the control version of software application 122 at computing devices 110-1 in control group 140 while enabling the control version of software application 122 to remain installed at the computing device.

Similarly, computing system 102 may send the control version of software application 122 to computing devices 110-1 in control group 140 that have not installed the control version of software application 122. Sending the control version of software application 122 to computing devices 110-1 in control group 140 that have not installed the control version of software application 122 may trigger those computing devices to upgrade the installed version of software application 122 to the control version of software application 122. As such, computing system 102 may, in response to determining that the version of software application 122 installed at a computing device in control group 140 is not the control version of software application 122, send the control version of software application 122 to the computing device, which causes the computing device to install the control version of software application 122 from a storage device of the computing devices.

In this way, computing system 102 may be able to increase the number of computing devices 110-1 in control group 140 at which the control version of software application 122 is installed. Increasing the number of computing devices 110-1 in control group 140 at which the control version of software application 122 is installed may decrease any imbalance between the number of computing devices 110-1 in control group 140 at which the control version of software application 122 is installed and the number of computing devices 110-2 in treatment group 142 at which the treatment version of software application 122 is installed

Computing system 102 may determine the version of software application 122 installed at computing devices 110-1 in control group 140 in any suitable manner. For example, testing data store 108 may store indications of the version of software application 122 installed at each of computing devices 110, and computing system 102 may use testing data store 108 to look up the version of software application 122 installed at computing devices 110-1 in control group 140 as indicated by testing data store 108.

Computing system 102 may send the determined version of software application 122 to computing devices 110 in any form. As described above, computing system 102 may send the determined version of software application 122 in the form of a software update to update software application 122 to the determined version of software application 122. The software update may include a package, an archive file, or any other technique for bundling code and resources, and may be compressed or uncompressed.

In some examples, a software update may include code and data to install the determined version of software application 122 in place of the currently installed version of software application 122. That is, application management module 116 may, in response to receiving the software update, replace the currently installed version of software application 122 with the determined version of software application 122.

In some examples, a software update may include code and data to patch the currently installed version of software application 122 to upgrade software application 122 to the determined version of software application 122. That is, application management module 116 may, in response to receiving the software update, patch the currently installed version of software application 122 to update the currently installed version of software application 122 to the determined version of software application 122.

In some examples, a software update may include modular updates to software application 122. Such modular updates may update specific features and functionality of software application 122, referred to herein as modules, to the determined version of such features and functionality. A software update for updating one or more modules of software application 122 may include code and data to install the determined version of the one or more modules in a currently installed version of software application 122, and/or may include code and data to patch the one or more modules in a currently installed version of software application 122 to update those one or more modules in software application 122 to the determined version of the one or more modules.

In the example of FIG. 1, computing system 102 may receive, from computing device 110-1A in control group 140, a request to update software application 122 installed at computing device 110-1A. Computing system 102 may, in response, determine the version of software application 122 installed at computing device 110-1A. If computing system 102 determines that the version of software application 122 installed at computing device 110-1A is the control version of software application 122, computing system 102 may send, to computing device 110-1A, a software update to update software application 122 to the treatment version of software application 122 to trigger computing device 110-1A to re-install the control version of software application 122 from a storage device of computing device 110-1A. That is, computing device 110-1A may store data for re-installing the control version of software application 122, such as an installer package, an application package, etc., on disk, and the receipt of the treatment version of software application 122 may cause computing device 110-1A to re-install the control version of software application 122 from a storage device of computing device 110-1A.

Similarly, if computing system 102 determines that the version of software application 122 installed at computing device 110-1A is not the control version of software application 122, computing system 102 may, in response, send, to computing device 110-1A, a software update to update software application 122 to the control version of software application 122. Computing device 110-1A may, in response to receiving the software update to update software application 122 to the control version of software application 122, use the received software update to update software application 122 installed at computing device 110-1A to the control version of software application 122.

Computing device 110-1A may, in response to receiving the software update, determine whether to re-install the currently installed version of software application 122 from the computing device 110-1A′s storage device or to upgrade to the received version of software application 122 based at least in part on determining whether the computing device is in a testing state, also referred to as a canary state. Computing devices 110-1A may be in a testing state when a control-treatment experiment is being performed to test a treatment version of software application 122, and may not be in the testing state when a control-treatment experiment is not being performed to test a treatment version of software application 122. If computing device 110-1A determines that the computing device is not in the testing state, the computing device may install the version of software application 122 from computing system 102.

Computing device 110-1A may determine whether the computing device is in a testing state via any suitable technique. In some examples, computing device 110-1A may receive, from computing system 102, an indication of whether computing device 110-1A is in a testing state along with the software update. In some examples, computing device 110-1A may store an indication of whether computing device 110-1A is in the testing state, which computing device 110-1A may update each time computing device 110-1A enters or exits the testing state. In some examples, computing device 110-1A may query computing system 102 regarding whether computing device 110-1A is in the testing state, and may receive, from computing system 102, a response indicating whether computing device 110-1A is in the testing state.

If computing device 110-1A determines that the computing device is in the testing state, computing device 110-1A may determine whether to re-install the currently installed version of software application 122 from computing device 110-1A′s storage device or to upgrade to the received version of software application 122 based at least in part on the version of software application 122 associated with the software update received from computing system 102. If computing device 110-1A determines that the software update received from computing system 102 is a software update for upgrading software application 122 to the treatment version of software application 122, computing device 110-1A may determine to re-install the currently installed version of software application 122 from computing device 110-1A′s storage device. In this way, computing system 102 may trigger computing device 110-1A to re-install the currently installed version of software application 122 from computing device 110-1A′s storage device by sending, to computing device 110-1A, a software update for upgrading software application 122 to the treatment version of software application 122.

In some examples, along with re-installing the currently installed version of software application 122 from computing device 110-1A′s storage device, computing device 110-1A may also use the received update to install a copy of the treatment version of software application 122 and may store the copy of the treatment version of software application 122 in a storage device of computing device 110-1A. Installing and storing a copy of the treatment version of software application 122 may enable computing device 110-1A to, at a future time, such as when the treatment version of software application 122 is released as the next official version of software application 122, upgrade the version of software application 122 installed at computing device 110-1A to the treatment version of software application 122 without having to re-download a software update for upgrading software application 122 to the treatment version of software application 122.

For example, when the treatment version of software application 122 is released as the next official version of software application 122, computing system 102 may send, to computing device 110-1A, an indication that the treatment version of software application 122 is released as the next official version of software application 122 that triggers computing device 110-1A to install the copy of the treatment version of the software application 122 stored at computing device 110-1A to replace the control version of the software application 122 currently installed at computing device 110-1A. Such an indication sent to computing device 110-1A may not have to include a software update to update software application 122 to the treatment version of software application 122 because a copy of the treatment version of software application 122 may already be stored at computing device 110-1A. thereby reducing bandwidth usage of computing device 110-1A because computing device 110-1A may not have to re-download a software update to update software application 122 to the treatment version of software application 122.

Similarly, if computing device 110-1A determines that the software update received from computing system 102 is a software update for upgrading software application 122 to the control version of software application 122, computing device 110-1A may use the software update to upgrade the currently installed version of software application 122 to the control version of software application 122. For example, computing device 110-1A may install the control version of software application 122 to replace the currently installed version of software application 122, update one or more modules of the currently installed version of software application 122 to the treatment versions of the one or more modules, and the like.

In some examples, computing system 102 may, regardless of the version of software application 122 installed at a computing device, send a software update to the computing device that includes both code for updating software application 122 to the treatment version of software application 122 and code for updating software application 122 to the control version of software application 122. A computing device in control group 140 may use the code for updating software application 122 to the control version of software application 122 to update software application 122 installed at the computing device to the control version of software application. Similarly, a computing device in treatment group 142 may use the code for updating software application 122 to the treatment version of software application 122 to update software application 122 installed at the computing device to the treatment version of software application 122.

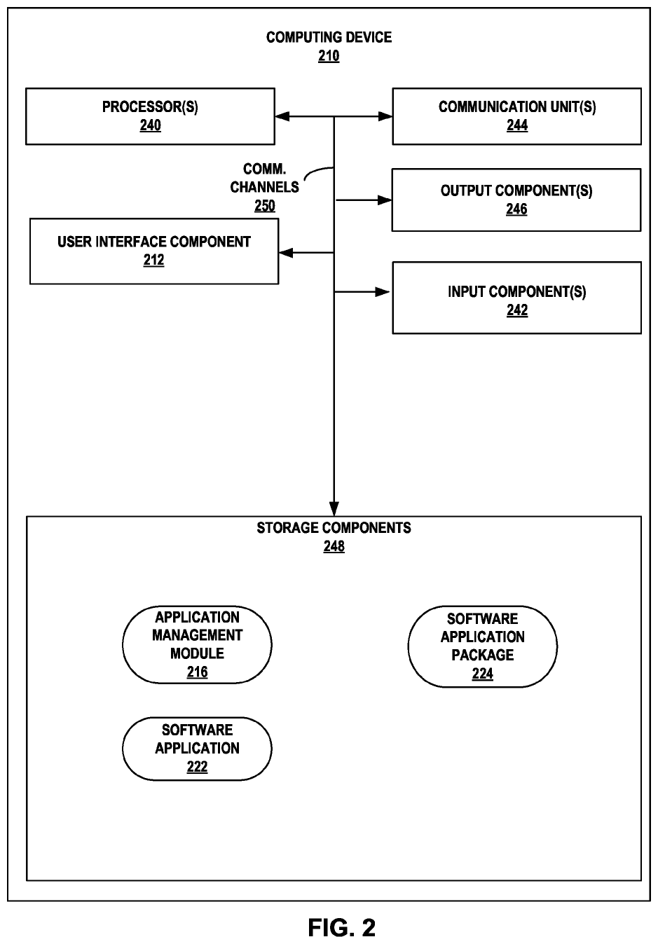

FIG. 2 is a block diagram illustrating further details of an example computing device, in accordance with one or more aspects of the present disclosure. Computing device 210 of FIG. 2 is described below as an example of any of computing devices 110-1 in control group 140 as illustrated in FIG. 1

Computing device 210 of FIG. 2 may be an example of a mobile phone, a tablet computer, a laptop computer, a desktop computer, a server, a mainframe, a set-top box, a television, a wearable device, a home automation device or system, a gaming system, a media player, an e-book reader, a mobile television platform, an automobile navigation or infotainment system, or any other type of mobile, non-mobile, wearable, and non-wearable computing device configured to receive, and output an indication of notification data. FIG. 2 illustrates only one particular example of computing device 210, and many other examples of computing device 210 may be used in other instances and may include a subset of the components included in example computing device 210 or may include additional components not shown in FIG. 2.

As shown in the example of FIG. 2, computing device 210 includes UIC 212, one or more processors 240, one or more input components 242, one or more communication units 244, one or more output components 246, and one or more storage components 248. Storage components 248 of computing device 210 also include application management module 216, software application 222, and software application package 224.

Communication channels 250 may interconnect each of the components 240, 212, 244, 246, 242, and 248 for inter-component communications (physically, communicatively, and/or operatively). In some examples, communication channels 250 may include a system bus, a network connection, an inter-process communication data structure, or any other method for communicating data.

One or more input components 242 of computing device 210 may receive input. Examples of input are tactile, audio, and video input. Input components 242 of computing device 210, in one example, includes a presence-sensitive display, touch-sensitive screen, mouse, keyboard, voice responsive system, video camera, microphone or any other type of device for detecting input from a human or machine.

One or more output components 246 of computing device 210 may generate output. Examples of output are tactile, audio, and video output. Output components 246 of computing device 210, in one example, includes a presence-sensitive display, sound card, video graphics adapter card, speaker, liquid crystal display (LCD), organic light-emitting diode (OLED) display, a light field display, haptic motors, linear actuating devices, or any other type of device for generating output to a human or machine.

One or more communication units 244 of computing device 210 may communicate with external devices via one or more wired and/or wireless networks by transmitting and/or receiving network signals on the one or more networks. Examples of one or more communication units 244 include a network interface card (e.g., an Ethernet card), an optical transceiver, a radio frequency transceiver, a GPS receiver, or any other type of device that can send and/or receive information. Other examples of one or more communication units 244 may include short wave radios, cellular data radios, wireless network radios, as well as universal serial bus (USB) controllers.

UIC 212 of computing device 200 may be hardware that functions as an input and/or output device for computing device 210. For example, UIC 212 may include a display component, which may be a screen at which information is displayed by UIC 212 and a presence-sensitive input component that may detect an object at and/or near the display component.

One or more processors 240 may implement functionality and/or execute instructions within computing device 210. For example, one or more processors 240 on computing device 210 may receive and execute instructions stored by storage components 248 that execute the functionality of modules 216 and 222 and package 224. The instructions executed by one or more processors 240 may cause computing device 210 to store information within storage components 248 during program execution. Examples of one or more processors 240 include application processors, display controllers, sensor hubs, and any other hardware configured to function as a processing unit. One or more processors 240 may execute instructions of modules 216 and 222 and package 224 to perform actions or functions. That is, modules 216 and 222 and package 224 may be operable by one or more processors 240 to perform various actions or functions of computing device 210.

One or more storage components 248 within computing device 210 may store information for processing during operation of computing device 210. That is, computing device 210 may store data accessed by modules 216 and 222 and package 224 during execution at computing device 210. In some examples, storage component 248 is a temporary memory, meaning that a primary purpose of storage component 248 is not long-term storage. Storage components 248 on computing device 210 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage components 248, in some examples, also include one or more computer-readable storage media. Storage components 248 may be configured to store larger amounts of information than volatile memory. Storage components 248 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage components 248 may store program instructions and/or information (e.g., data) associated with modules 216 and 222 and package 224. Application management module 216 and software application 222 may execute at one or more processors 240 to perform functions similar to that of application management module 116 and software application 122 of FIG. 1.

One or more processors 240 is configured to execute application management module 216 to perform functions associated with receiving, managing, and otherwise handling software updates received at computing device 210. Specifically, application management module 216 may execute at one or more processors 240 to receive a software update for updating software application 222 from a computing system (e.g., computing system 102 of FIG. 1). Because computing device 210 is in a control group for a control-treatment experiment, application management module 216 may either receive a software update for updating software application 222 to a treatment version of software application 222 or a software update for updating software application 222 to a control version of software application 222.

Application management module 216 may, in response to receiving the software update, determine whether to re-install the currently installed version of software application 222 or to upgrade to the received version of software application 222. If application management module 216 determines to re-install the currently installed version of software application 222, application management module 216 may use software application package 224 to re-install the currently installed version of software application 222, where software application package 224 may be a software installation package for re-installing the currently installed version of software application 222 at computing device 210.

In some examples, application management module 216 may determine, based at least in part on determining whether computing device 210 is in a testing state, also referred to as a canary state, whether to re-install the currently installed version of software application 222 from software application package 224 or to upgrade to the received version of software application 222. Computing device 210 may be in a testing state when a control-treatment experiment is being performed on software application 222, and may not be in the testing state when a control-treatment experiment is not being performed on software application 222. If application management module 216 determines that the computing device is not in the testing state, the computing device may install the version of software application 222 received by application management module 216 from a computing system (e.g., computing system 102 of FIG. 1).

Application management module 216 may determine whether computing device 210 is in a testing state via any suitable technique. In some examples, application management module 216 may receive, from a computing system, an indication of whether computing device 210 is in a testing state along with the software update. In some examples, application management module 216 may store, in storage components 248, an indication of whether computing device 210 is in the testing state, which application management module 216 may update each time computing device 210 enters or exits the testing state. In some examples, application management module 216 may query a computing system regarding whether computing device 210 is in the testing state, and may receive, from the computing system, a response indicating whether computing device 210 is in the testing state.

If application management module 216 determines that the computing device is in the testing state, application management module 216 may determine whether to re-install the currently installed version of software application 222 from software application package 224 stored in storage components 248 or to upgrade software application 222 using the received software update based at least in part on the version of software application 222 associated with the software update received from the computing system. If application management module 216 determines that the received software update is a software update for upgrading software application 222 to the treatment version of software application 222, application management module 216 may determine to re-install the currently installed version of software application 222 using software application package 224 stored in storage components 248. In this way, a computing system may trigger computing device 210 to re-install the currently installed version of software application 222 using software application package 224 stored in storage components 248 by sending, to computing device 210, a software update for upgrading software application 222 to the treatment version of software application 222.

In some examples, along with re-installing the currently installed version of software application 222 using software application package 224 stored in storage components 248 computing device 110-1A may also use the received update to install a copy of the treatment version of software application 222 and may store the copy of the treatment version of software application 222 in storage components 248. Installing and storing a copy of the treatment version of software application 222 may enable computing device 210 to, at a future time, upgrade the version of software application 222 installed at computing device 210 to the treatment version of software application 222 without having to re-download a software update for upgrading software application 222 to the treatment version of software application 222.

Similarly, if application management module 216 determines that the software update received from a computing system is a software update for upgrading software application 222 to the control version of software application 222, application management module 216 may use the software update to upgrade the currently installed version of software application 222 to the control version of software application 222. For example, application management module 216 may install the control version of software application 222 to replace the currently installed version of software application 222, update one or more modules of the currently installed version of software application 222 to the treatment versions of the one or more modules, and the like.

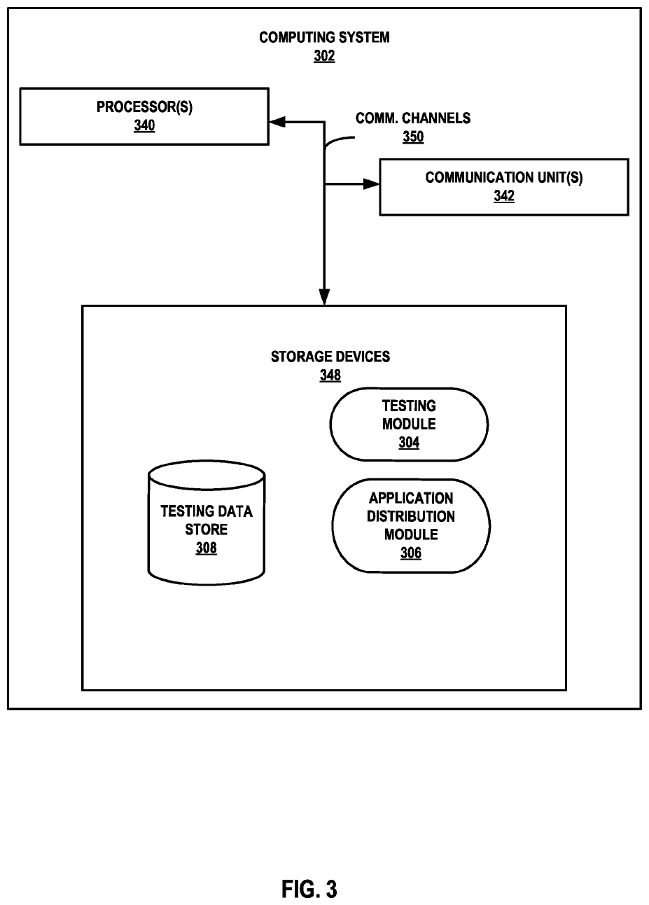

FIG. 3 is a block diagram illustrating an example computing system, in accordance with one or more aspects of the present disclosure. Computing system 302 of FIG. 3 is described below as an example of computing system 102 of FIG. 1. FIG. 3 illustrates only one particular example of computing system 302, and many other examples of computing system 302 may be used in other instances and may include a subset of the components included in example computing system 302 or may include additional components not shown in FIG. 3. For example, computing system 302 may comprise a cluster of servers, and each of the servers comprising the cluster of servers making up computing system 302 may include all, or some, of the components described herein in FIG. 3, to perform the techniques disclosed herein.

As shown in the example of FIG. 3, computing system 302 includes one or more processors 340, one or more communication units 342, and one or more storage devices 348. Storage devices 348 include testing module 304, application distribution module 306, and testing data store 308.

One or more processors 340 may implement functionality and/or execute instructions associated with computing system 310. Examples of one or more processors 340 include application processors, display controllers, auxiliary processors, one or more sensor hubs, and any other hardware configure to function as a processor, a processing unit, or a processing device. Testing module 304 and application distribution module 306 may be operable by one or more processors 340 to perform various actions, operations, or functions of computing system 310. For example, one or more processors 340 of computing system 310 may retrieve and execute instructions stored by one or more storage components 348 that cause one or more processors 340 to perform the operations of testing module 304 and application distribution module 306. The instructions, when executed by one or more processors 340, may cause computing system 310 to store information within one or more storage components 348, for example, at testing data store 308.

One or more communication units 342 of computing system 310 may communicate with external devices via one or more wired and/or wireless networks by transmitting and/or receiving network signals on the one or more networks. Examples of one or more communication units 342 include a network interface card (e.g., such as an Ethernet card), an optical transceiver, a radio frequency transceiver, a global positioning satellite (GPS) receiver, or any other type of device that can send and/or receive information. Other examples of one or more communication units 342 may include short wave radios, cellular data radios, wireless network radios, as well as universal serial bus (USB) controllers.

Communication channels 350 may interconnect each of the components 340, 342, and 348 for inter-component communications (physically, communicatively, and/or operatively). In some examples, communication channels 350 may include a system bus, a network connection, an inter-process communication data structure, or any other method for communicating data.

One or more storage components 348 within computing system 310 may store information for processing during operation of computing system 310 (e.g., computing system 310 may store data accessed by testing module 304, application distribution module 306, and testing data store 308 during execution at computing system 310). In some examples, one or more storage devices 348 is a temporary memory, meaning that a primary purpose of one or more storage devices 348 is not long-term storage. In this example, one or more storage devices 348 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

In some examples, one or more storage devices 348 may also include one or more computer-readable storage media. One or more storage devices 348, in some examples, include one or more non-transitory computer-readable storage mediums. One or more storage devices 348 may be configured to store larger amounts of information than typically stored by volatile memory. One or more storage devices 348 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. One or more storage devices 348 may store program instructions and/or information (e.g., data) associated with testing module 304, application distribution module 306, and testing data store 308. Storage devices 348 may include a memory configured to store data or other information associated with testing module 304, application distribution module 306, and testing data store 308.

Testing data store 308 may be any data storage mechanism for storing structured and/or unstructured data, and may be configured to store any data related to control-treatment experiments on software applications. For example, testing data store 308 may store versions of a software application being tested, indications of the versions of software applications installed at computing devices, and the like. Examples of testing data store 308 may include a database, a schema, a key-value store, and the like.

One or more processors 340 is configured to execute application distribution module 306 and testing module 304 to perform a control-treatment experiment for a software application. Specifically, one or more processors 340 is configured to execute application distribution module 306 to distribute software applications to computing devices via one or more communication units 342. In some examples, application distribution module 306 may generate and send software updates for updating software applications to computing devices via one or more communication units 342. That is, in some examples, when application distribution module 306 receives (e.g., from testing module 304) a request to send a version of a software application to one or more computing devices, application distribution module 306 may generate a software update for updating the software application to the version of the software application, and may send the software update to the one or more computing devices.

One or more processors 340 is configured to execute testing module 304 to perform a control-treatment experiment for a software application. Treatment module 304 may receive a treatment version of a software application to be deployed at computing devices (e.g., computing devices 110 of FIG. 1) in the treatment group for testing of the software application, and application distribution module 306 may, in response use application distribution module 306 to send, via one or more communication units 342, the treatment version of the software application to the computing devices in the treatment group. For example, application distribution module 306 may, in response to receiving a request from testing module 304 to send the treatment version of the software application, generate a software update for updating the software application to the treatment version of the software application, and may send, to the computing devices in the treatment group, the software update for updating the software application to the treatment version of the software application.

Correspondingly, when testing module 304 sends, using application distribution module 306, the treatment version of the software application to the computing devices in the treatment group, the testing module 304 may also use application distribution module 306 to send one or more versions of the software application to computing devices in the control group for testing of the software application. Specifically, testing module 304 may determine, for each computing device in the control group for testing of the software application, the version of the software application installed at the computing device. If testing module 304 determines that the version of the software application installed at the computing device in the control group is not the control version of the software application, testing module 304 may send, via application distribution module 306, the control version of the software application to the computing device.

Similarly, if testing module 304 determines that the version of the software application installed at the computing device in the control group is the control version of the software application, testing module 304 may send, via application distribution module 306, the treatment version of the software application to the computing device. Sending the treatment version of the software application to a computing device in the control group that has installed the control version of the software application may trigger the computing device to re-install the control version of the software application from a storage device of the computing devices.

As described above, application distribution module 306 may send, via one or more communication units 342, a version of the software application (e.g., the treatment version of the software application or the control version of the software application) in any form to one or more computing devices in the control group. to send, via one or more communication units 342, the treatment version of the software application to the computing devices in the treatment group. For example, application distribution module 306 may, in response to receiving a request from testing module 304 to send a specified version of the software application to a computing device, generate a software update for updating the software application to the specified version of the software application, and may send, to the computing device, the software update for updating the software application to the specified version of the software application.

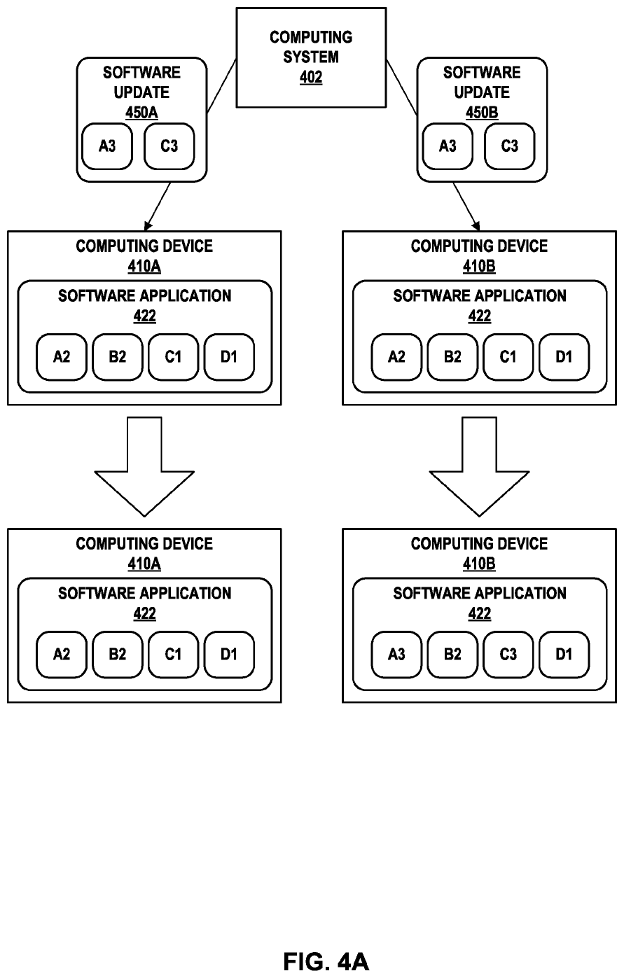

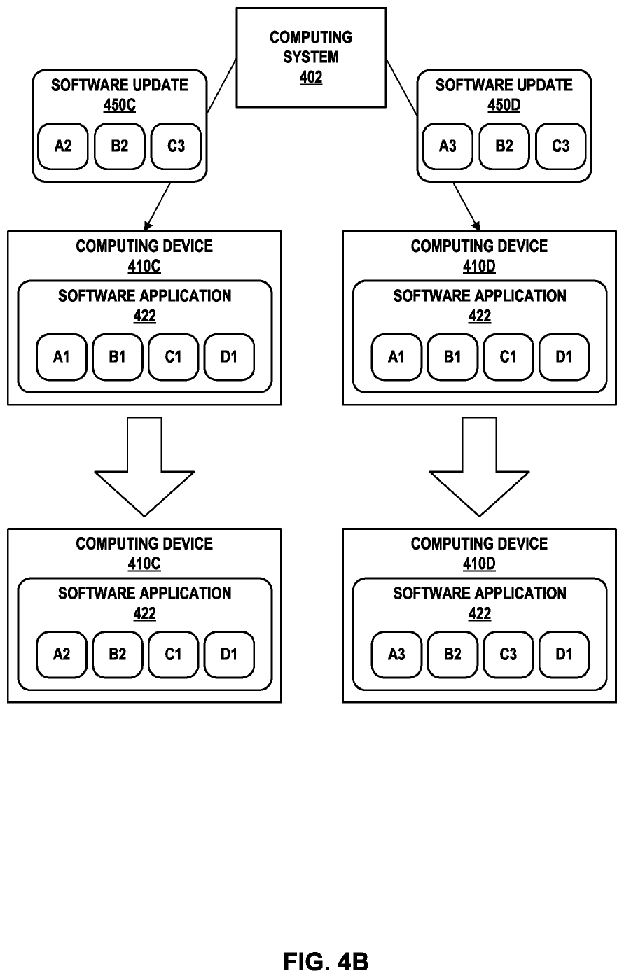

FIGS. 4A-4B are block diagrams illustrating software testing, in accordance with aspects of this disclosure. As shown in FIG. 4A, computing system 402, which is an example of computing system 102 of FIG. 1, may communicate with computing devices 410A and 410B, which are examples of computing devices 110 of FIG. 1, to perform testing of software application 422. Computing device 410A may be in a control group for performing a control-treatment experiment on software application 422, while computing device 410B may be in a treatment group for performing a control release experiment.

Software application 422 may include modules A, B, C, and D, and the control version of software application 422 may include version 2 of module A, version 2 of module B, version 1 of module C, and version 1 of module D. Computing devices 410A and 410B may each have installed the control version of software application 422. As such, each of software application 422 installed at computing devices 410A and 410B includes version 2 of module A, version 2 of module B, version 1 of module C, and version 1 of module D.

As part of performing a control-treatment experiment, computing system 402 may deploy the treatment version of software application 422 to computing devices in the treatment group for the control-treatment experiment. While the control version of software application 422 includes version 2 of module A, version 2 of module B, version 1 of module C, and version 1 of module D, the treatment version of software application 422 may include version 3 of module A, version 2 of module B, version 3 of module C, and version 1 of module D. As such, upgrading the control version of software application 422 to the treatment version of software application 422 may include upgrading version 2 of module A in the control version of software application 422 to version 3 of module A, and upgrading version 1 of module C in the control version to version 3 of module C.

Computing system 402 may therefore deploy the treatment version of software application 422 in the form of a software update that updates version 2 of module A in the control version of software application 422 to version 3 of module A, and that updates version 1 of module C in the control version to version 3 of module C. In some examples, the software update may include code for installing the complete treatment version of software application 422. That is, the software update may install each of version 3 of module A, version 2 of module B, version 3 of module C, and version 1 of module D included in the treatment version of software application 422.

In some examples, the software update may update the control version of software application to the treatment version of software application 422 by including code for updating fewer than all of the control version of software application 422 to the treatment version of software application 422. That is, the software update may instead update only the portions of the control version of software application 422 that are different from the treatment version of software application 422. In the example of FIG. 4A, because only module A and module C of the control version of software application 422 are different from the treatment version of the software application 422, the software update may update module A and module C of the control version of software application 422 to the treatment version of module A and module C.

As such, computing system 402 may send, to computing device 410B, software update 450B for updating module A and module C of the control version of software application 422 to the treatment version of module A and module C (e.g., version 3 of module A and version 3 of module C). Software update 450B may include code for installing the treatment version of module A and module C, such as by replacing the control version of module A and module C with the treatment version of module A and module C, patching the control version of module A and module C to the treatment version of module A and module C, or otherwise updating the control version of module A and module C to the treatment version of module A and module C.

Computing device 410B may, in response to receiving software update 450B, apply software update 450B to update the control version of software application 422 to the treatment version of software application 422. That is, computing device 410B may replace the control version of module A and module C with the treatment version of module A and module C, patch the control version of module A and module C to the treatment version of module A and module C, or otherwise update the control version of module A and module C to the treatment version of module A and module C, to result in the treatment version of software application 422 that includes version 3 of module A, version 2 of module B, version 3 of module C, and version 1 of module D being installed at computing device 410B

Computing system 402 may correspondingly send software update 450A to computing device 410A in the control group for the control-treatment experiment. Computing system 402 may determine that the control version of software application 422 is installed at computing device 410A and may, in response, send, to computing device 410A, software update 450A for updating software application 422 to the treatment version of software application 422 to trigger computing device 410A to re-install the control version of software application 422 from a storage device of computing device 410A.

In the example of FIG. 4A, software update 450A sent to computing device 410A includes code for updating the same modules as software update 450B sent to computing device 410B. That is, software update 450A includes code for installing the treatment version of module A and module C, such as by replacing the control version of module A and module C with the treatment version of module A and module C, patching the control version of module A and module C to the treatment version of module A and module C, or otherwise updating the control version of module A and module C to the treatment version of module A and module C.

Computing device 410A may, in response to receiving software update 450A, determine whether to install software update 450A or to re-install the control version of software application 422 from a storage device of computing device 410A. For example, computing device 410A may determine whether the currently installed version of software application 422 is the control version of software application 422, and may determine to re-install the current version of software application 422 if the currently installed version of software application 422 is the control version of software application 422.

If computing device 410A determines to re-install the control version of software application 422, computing device 410A may re-install the control version of software application 422 from a storage device of computing device 410A. That is, computing device 410A may store data for re-installing the control version of software application 422, such as an installer package, an application package, etc., on disk. As such, computing device 410A may, in response to receiving software update 450A, re-install the control version of software application 422 using the data for re-installing the control version of software application 422 stored in disk storage (e.g., hard drive) of computing device 410A. In some examples, computing device 410A may also store software update 450A in the storage device of computing device 410A, which may be used by computing device 410A at a later time to upgrade the control version of software application 422 to the treatment version of software application 422 without having to re-download a software update for upgrading software application 422 to the treatment version of software application 422.

In some examples, when computing system 402 determines to send a software update for updating software application 422 to the control version of software application 422, the computing system 402 may generate a software update that includes code for updating the same modules that is updated by a software update for updating software application 422 to the treatment version of software application 422. That is, even if the software update for updating software application 422 to the control version of software application 422 updates some, but not all, of the modules updated by the updated by a software update for updating software application 422 to the treatment version of software application 422, the software update for updating software application 422 to the control version of software application 422 may nonetheless include code for updating the same modules that is updated by a software update for updating software application 422 to the treatment version of software application 422. By including code for updating the same modules that is updated by a software update for updating software application 422 to the treatment version of software application 422, the software update for updating software application 422 to the control version of software application 422 may be closer in size to the software update for updating software application 422 to the treatment version of software application 422, thereby reducing the amount of skew introduced by size differences between these software updates when comparing performance data associated with the downloads of these software updates.

As shown in FIG. 4B, computing system 402, which is an example of computing system 102 of FIG. 1, may communicate with computing devices 410C and 410D, which are examples of computing devices 110 of FIG. 1, to perform testing of software application 422. Computing device 410C may be in a control group for performing a control-treatment experiment on software application 422, while computing device 410D may be in a treatment group for performing a control release experiment.

Software application 422 may include modules A, B, C, and D, and the control version of software application 422 may include version 2 of module A, version 2 of module B, version 1 of module C, and version 1 of module D. However, neither computing device 410C nor computing device 410D has installed the control version of software application 422. Instead, each of computing devices 410C and 410B may have installed an older version of software application 422 that includes version 1 of module A, version 1 of module B, version 1 of module C, and version 1 of module D.

As part of performing a control-treatment experiment, computing system 402 may deploy the treatment version of software application 422 to computing devices in the treatment group for the control-treatment experiment. While the version of software application 422 installed at computing device 410D includes version 1 of module A, version 1 of module B, version 1 of module C, and version 1 of module D, the treatment version of software application 422 may include version 3 of module A, version 2 of module B, version 3 of module C, and version 1 of module D. As such, upgrading the control version of software application 422 to the treatment version of software application 422 may include upgrading version 1 of module A in the control version of software application 422 to version 3 of module A, upgrading version 1 of module B to version 2 of module B, and upgrading version 1 of module C in the control version to version 3 of module C.

Computing system 402 may therefore deploy the treatment version of software application 422 in the form of a software update 450D to computing device 410D that updates version 1 of module A in the control version of software application 422 to version 3 of module A, that updates version 1 of module B to version 2 of module B, and that updates version 1 of module C in the control version to version 3 of module C. In some examples, the software update may include code for installing the complete treatment version of software application 422. That is, the software update may install each of version 3 of module A, version 2 of module B, version 3 of module C, and version 1 of module D included in the treatment version of software application 422. Computing device 410B may, in response to receiving software update 450D, apply software update 450D to update the version of software application 422 installed at computing device 410B to the treatment version of software application 422.

Computing system 402 may correspondingly send software update 450C to computing device 410C in the control group for the control-treatment experiment. Computing system 402 may determine that the version of software application 422 installed at computing device 410C is not the control version of software application 422 and may, in response, send, to computing device 410C, software update 450C for updating software application 422 to the control version of software application 422.

The control version of software application 422 includes version 2 of module A, version 2 of module B, version 1 of module C, and version 1 of module D. As such, a software update for updating software application 422 to the control version of software application 422 may include at least code for updating version 1 of module A in the control version of software application 422 to version 2 of module A and for updating version 1 of module B to version 2 of module B.

However, a software update that includes only code for updating version 1 of module A in software application 422 to version 2 of module A and for updating version 1 of module B in software application 422 to version 2 of module B does not include code for updating module C, unlike update 450D. As such, computing system 402 may send, to computing device 410C, software update 450C that includes code for updating version 1 of module A in software application 422 to version 2 of module A and for updating version 1 of module B in software application 422 to version 2 of module B, and code for updating module C in software application 422 to version 3 of module C.

Computing device 410C may, in response to receiving software update 450C, determine whether to install software update 450C or to re-install the currently installed version of software application 422 from a storage device of computing device 410C. For example, computing device 410C may determine whether the currently installed version of software application 422 is the control version of software application 422, and may determine to re-install the current version of software application 422 if the currently installed version of software application 422 is the control version of software application 422.

In the example of FIG. 4B, computing device 410C may determine that the currently installed version of software application 422 is not the control version of software application 422, and may therefore install software update 450C to update the version of software application 422 installed at computing device 410C to the control version of software application 422. Specifically, computing device 410C may utilize software update 450C to update version 1 of module A in software application 422 to version 2 of module A and to update version 1 of module B to version 2 of module B. Further, because the control version of software application 422 does not include updated versions of modules C and D, computing device 410C may, as part of updating software application 422 to the control version of software application 422, also re-install version 1 of module C and version 1 of module D from the storage device of computing device 410C. In this way, computing device 410C may update an older version of software application 422 to the control version of software application 422.

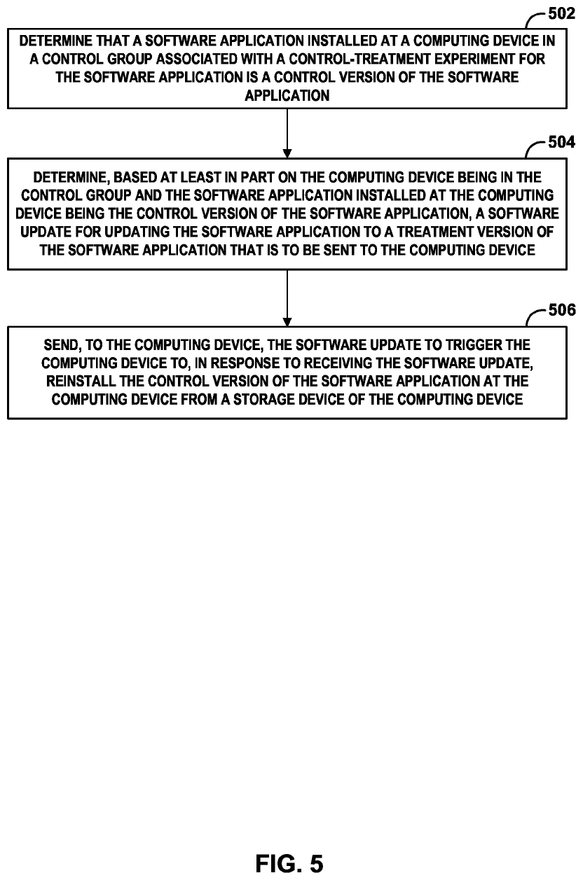

FIG. 5 is a flowchart illustrating example operations performed by an example computing system that is configured to perform software testing, in accordance with one or more aspects of the present disclosure. FIG. 5 is described below in the context of environment 100 of FIG. 1 and computing system 302 of FIG. 3.

As shown in FIG. 5, one or more processors 340 of computing system 302 may determine that a software application 122 installed at a computing device 110-1A in a control group 140 associated with a control-treatment experiment for the software application 122 is a control version of the software application 122 (502). The one or more processors 340 may determine, based at least in part on the computing device 110-1A being in the control group 140 and the software application 122 installed at the computing device 110-1A being the control version of the software application 122, a software update for updating the software application 122 to a treatment version of the software application 122 to be sent to the computing device 110-1A (504). The one or more processors 340 may send, to the computing device 110-1A, the software update to trigger the computing device 110-1A to, in response to receiving the software update, reinstall the control version of the software application 122 at the computing device 110-1A from a storage device of the computing device 110-1A (506).

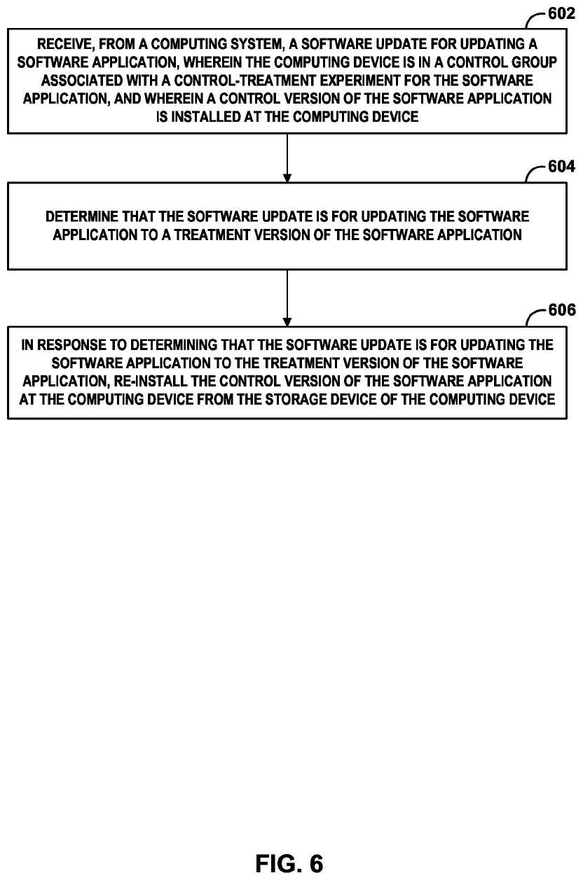

FIG. 6 is a flowchart illustrating example operations performed by an example computing device that is in a control group for a control-treatment experiment to test a software application, in accordance with one or more aspects of the present disclosure. FIG. 6 is described below in the context of environment 100 of FIG. 1 and computing device 210 of FIG. 2.

As shown in FIG. 6, one or more processors 240 of computing device 210 may receive, from a computing system 102, a software update for updating a software application 222, wherein the computing device 210 is in a control group associated with a control-treatment experiment for the software application 222, and wherein a control version of the software application 222 is installed at the computing device (602). The one or more processors 240 may determine that the software update is for updating the software application 222 to a treatment version of the software application 222 (604). The one or more processors 240 may, in response to determining that the software update is for updating the software application 222 to the treatment version of the software application 222, re-install the control version of the software application 222 at the computing device 210 from a storage device 248 of the computing device 210 (606).

Aspects of this disclosure include the following examples.

Example 1: A method includes determining, by one or more processors of a computing system, that a software application installed at a computing device in a control group associated with a control-treatment experiment for the software application is a control version of the software application; determining, by the one or more processors and based at least in part on the computing device being in the control group and the software application installed at the computing device being the control version of the software application, a software update for updating the software application to a treatment version of the software application that is to be sent to the computing device; and sending, by the one or more processors to the computing device, the software update to trigger the computing device to, in response to receiving the software update, reinstall the control version of the software application at the computing device from a storage device of the computing device.

Example 2: The method of example 1, further includes sending, by the one or more processors to a plurality of computing devices in a treatment group associated with the control-treatment experiment for the software application, the software update for updating the software application to the treatment version of the software application.

Example 3: The method of any of examples 1 and 2, wherein the software update for updating the software application includes code for updating the software application to the control version of the software application and code for updating the software application to the treatment version of the software application.

Example 4: The method of any of examples 1-3, further includes determining, by the one or more processors, whether the software application installed at a second computing device in the control group is the control version of the software application; and responsive to determining that the software application installed at a second computing device is not the control version of the software application, sending, by the one or more processors to the second computing device, a second software update for updating the software application to the control version of the software application.

Example 5: The method of any of examples 1-4, further includes determining, by the one or more processors, the control version of the software application as one of: a version of the software application that is fully released to computing devices or a most recent version of the software application prior to deployment of the treatment version of the software application to the plurality of computing devices in the treatment group.

Example 6: The method of any of examples 1-5, wherein sending the software update further comprises: receiving, by the one or more processors and from the computing device, an auto update request associated with the software application; and responsive to receiving the auto update request from the computing device, sending, by the one or more processors and to the computing device, the software update to trigger the computing device to, in response to receiving the software update, reinstall the control version of the software application at the computing device from the storage device of the computing device.

Example 7: The method of any of examples 1-6, wherein sending the software update to the computing device further triggers the computing device to store a copy of the treatment version of the software application in the storage device of the computing device, and the method further includes sending, by the one or more processors to the computing device, an indication that the treatment version of the software application is released as a next official version of the software application that causes the computing device to install the copy of the treatment version of the software application from the computing device to replace the control version of the software application.

Example 8: A computing system includes a memory that stores instructions; and one or more processors that execute the instructions to: determine that a software application installed at a computing device in a control group associated with a control-treatment experiment for the software application is a control version of the software application; determine, based at least in part on the computing device being in the control group and the software application installed at the computing device being the control version of the software application, a software update for updating the software application to a treatment version of the software application that is to be sent to the computing device; and send, to the computing device, the software update to trigger the computing device to, in response to receiving the software update, reinstall the control version of the software application at the computing device from a storage device of the computing device.

Example 9: The computing system of example 8, wherein the one or more processors further execute the instructions to: send, to a plurality of computing devices in a treatment group associated with the control-treatment experiment for the software application, the software update for updating the software application to a treatment version of the software application.

Example 10: The computing system of any of examples 8 and 9, wherein the software update for updating the software application includes code for updating the software application to the control version of the software application and code for updating the software application to the treatment version of the software application.

Example 11: The computing system of any of examples 8-10, wherein the one or more processors further execute the instructions to: determine that the software application installed at a second computing device in the control group is the control version of the software application; and responsive to determining that to the software application installed at a second computing device is not the control version of the software application, send, to the second computing device, a second software update for updating the software application to the control version of the software application.

Example 12: The computing system of any of examples 8-11, wherein the one or more processors further execute the instructions to: determine the control version of the software application as one of: a version of the software application that is fully released to computing devices or a most recent version of the software application prior to deployment of the treatment version of the software application to the plurality of computing devices in the treatment group.

Example 13: The computing system of any of examples 8-12, wherein to send the software update, the one or more processors further execute the instructions to: receive, from the computing device, an auto update request associated with the software application; and responsive to receiving the auto update request from the computing device, send, to the computing device, the software update to trigger the computing device to, in response to receiving the software update, reinstall the control version of the software application at the computing device from the storage device of the computing device.

Example 14: The computing system of any of examples 8-13, wherein the one or more processors further execute the instructions to send the software update to the computing device to further triggers the computing device to store a copy of the treatment version of the software application in the storage device of the computing device, further includes sending, by the one or more processors to the computing device, an indication that the treatment version of the software application is released as a next official version of the software application that causes the computing device to install the copy of the treatment version of the software application from the computing device to replace the control version of the software application.

Example 15: A non-transitory computer-readable storage medium includes instructions that, when executed by one or more processors of a computing system, cause the one or more processors to: determine that a software application installed at a computing device in a control group associated with a control-treatment experiment for the software application is a control version of the software application; determine, based at least in part on the computing device being in the control group and the software application installed at the computing device being the control version of the software application, a software update for updating the software application to a treatment version of the software application that is to be sent to the computing device; and send, to the computing device, the software update to trigger the computing device to, in response to receiving the software update, reinstall the control version of the software application at the computing device from a storage device of the computing device.

Example 16: The non-transitory computer-readable storage medium of example 15, wherein the instructions further cause the one or more processors to: send, to a plurality of computing devices in a treatment group associated with the control-treatment experiment for the software application, the software update for updating the software application to the treatment version of the software application.

Example 17: The non-transitory computer-readable storage medium of any of examples 15 and 16, wherein the software update for updating the software application includes code for updating the software application to the control version of the software application and code for updating the software application to the treatment version of the software application.

Example 18: The non-transitory computer-readable storage medium of any of examples 15-18, wherein the instructions further cause the one or more processors to: determine that the software application installed at a second computing device in the control group is not the control version of the software application; and in response to the second computing device being in the control group and to the software application installed at a second computing device not being the control version of the software application, send, to the second computing device, a second software update for updating the software application to the control version of the software application.

Example 19: The non-transitory computer-readable storage medium of any of examples 15-18, wherein the instructions further cause the one or more processors to: determine the control version of the software application as one of: a version of the software application that is fully released to computing devices or a most recent version of the software application prior to deployment of the treatment version of the software application to the plurality of computing devices in the treatment group.

Example 20: The non-transitory computer-readable storage medium of any of examples 15-19, wherein the instructions that cause the one or more processors to send the software update further cause the one or more processors to: receive, from the computing device, an auto update request associated with the software application; and in response to receiving the auto update request from the computing device, send, to the computing device, the software update to trigger the computing device to, in response to receiving the software update, reinstall the control version of the software application at the computing device from the storage device of the computing device.

Example 21: A method includes receiving, by one or more processors of a computing device and from a computing system, a software update for updating a software application, wherein the computing device is in a control group associated with a control-treatment experiment for the software application, and wherein a control version of the software application is installed at the computing device; determining, by the one or more processors, whether the software update is for updating the software application to a treatment version of the software application; and responsive to determining that the software update is for updating the software application to the treatment version of the software application, re-installing, by the one or more processors, the control version of the software application at the computing device from a storage device of the computing device.

Example 22: The method of example 21, wherein a software installation package for installing the control version of the software application is stored at the storage device of the computing device, and wherein re-installing the control version of the software application further comprises: re-installing, by the one or more processors, the control version of the software application at the computing device using the software installation package.

Example 23: The method of any of examples 21 and 22, wherein re-installing the control version of the software application further includes updating, by the one or more processors and using the software update, a copy of the control version of the software application to the treatment version of the software application; and storing, by the one or more processors in the storage device of the computing device, a copy of the treatment version of the software application.

Example 24: The method of example 23, wherein re-installing the control version of the software application at the computing device further comprises: in response to determining that the computing device is in a testing state, re-installing, by the one or more processors, the control version of the software application at the computing device from the storage device of the computing device.

Example 25: The method of example 24, further includes receiving, by the one or more processors and from the computing system, an indication that the computing device is in the testing state.

Example 26: The method of example 25, wherein receiving the indication that the computing device is in the testing state further comprises: sending, by the one or more processors and to the computing system, a query regarding whether the computing device is in the testing state; and in response to sending the query, receiving, by the one or more processors and from the computing system, the indication that the computing device is in the testing state.

Example 27: The method of any of examples 24-26, further includes determining, by the one or more processors, whether the computing device is in the testing state; and responsive to determining that the computing device is no longer in the testing state, installing, by the one or more processors, the copy of the treatment version of the software application stored at the computing device to replace the control version of the software application.

Example 28: The method of any of examples 21-27, wherein the software update for updating the software application includes code for updating the software application to the control version of the software application and code for updating the software application to the treatment version of the software application.

Example 29: The method of any of examples 21-28, wherein receiving the software update is responsive to sending, by the one or more processors to the computing system, a auto update request for the software application.

Example 30: A computing device includes a memory that stores instructions; a storage device; and one or more processors that execute the instructions to: receive, from a computing system, a software update for updating a software application, wherein the computing device is in a control group associated with a control-treatment experiment for the software application, and wherein a control version of the software application is installed at the computing device; determine whether the software update is for updating the software application to a treatment version of the software application; and responsive to determining that the software update is for updating the software application to the treatment version of the software application, re-install the control version of the software application at the computing device from the storage device of the computing device.

Example 31: The computing device of example 30, wherein the storage device of the computing device is configured to store software installation package for installing the control version of the software application, and wherein to re-install the control version of the software application, the one or more processors are further configured to: re-install the control version of the software application at the computing device using the software installation package.

Example 32: The computing device of any of examples 30 and 31, wherein to re-install the control version of the software application, the one or more processors further execute the instructions to: update, using the software update, a copy of the control version of the software application to the treatment version of the software application; and store, in the storage device of the computing device, a copy of the treatment version of the software application.

Example 33: The computing device of any of example 32, wherein re-installing the control version of the software application at the computing device further comprises: in response to determining that the computing device is in a testing state, re-install the control version of the software application at the computing device from the storage device of the computing device.

Example 34: The computing device of example 33, wherein the one or more processors are further configured to: receive, from the computing system, an indication that the computing device is in the testing state.

Example 35: The computing device of example 34, wherein to receive the indication that the computing device is in the testing state, the one or more processors are further configured to: send, to the computing system, a query regarding whether the computing device is in the testing state; and in response to sending the query, receive, from the computing system, the indication that the computing device is in the testing state.

Example 36: The computing device of any of examples 33-35, wherein the one or more processors are further configured to: determine whether the computing device is in the testing state; and responsive to determining that the computing device is no longer in the testing state, re-install the copy of the treatment version of the software application stored at the computing device to replace the control version of the software application.

Example 37: The computing device of any of examples 30-36, wherein the software update for updating the software application includes code for updating the software application to the control version of the software application and code for updating the software application to the treatment version of the software application.

Example 38: The computing device of any of examples 30-37, wherein the one or more processors are configured to receive the software update responsive to sending, to the computing system, an auto update request for the software application.

Example 39: A non-transitory computer-readable storage medium includes instructions that, when executed by one or more processors of a computing device, cause the one or more processors to receive, from a computing system, a software update for updating a software application, wherein the computing device is in a control group associated with a control-treatment experiment for the software application, and wherein a control version of the software application is installed at the computing device; determine whether the software update is for updating the software application to a treatment version of the software application; and responsive to determining that the software update is for updating the software application to the treatment version of the software application, re-install the control version of the software application at the computing device from a storage device of the computing device.

Example 40: The non-transitory computer-readable storage medium of example 39, wherein the instructions that cause the one or more processors to re-install the control version of the software application further cause the one or more processors to: update, using the software update, a copy of the control version of the software application to the treatment version of the software application; and store, in the storage device of the computing device, a copy of the treatment version of the software application.

By way of example, and not limitation, such computer-readable storage media can comprise RAM, ROM, EEPROM, CD-ROM or other optical disk storage, magnetic disk storage, or other magnetic storage devices, flash memory, or any other storage medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage mediums and media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of a computer-readable medium.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structures or any other structures suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of inter-operative hardware units, including one or more processors as described above, in conjunction with suitable software and/or firmware.

Various embodiments have been described. These and other embodiments are within the scope of the following claims.

1-20. (canceled)

21. A method comprising:
determining, by one or more processors of a computing system, that a software application installed at a computing device in a control group associated with a control-treatment experiment for the software application is a control version of the software application;
determining, by the one or more processors and based at least in part on the computing device being in the control group and the software application installed at the computing device being the control version of the software application, a software update for updating the software application to a treatment version of the software application that is to be sent to the computing device; and
sending, by the one or more processors to the computing device, the software update to trigger the computing device to, in response to receiving the software update, reinstall the control version of the software application at the computing device from a storage device of the computing device.

22. The method of claim 21, further comprising:
sending, by the one or more processors to a plurality of computing devices in a treatment group associated with the control-treatment experiment for the software application, the software update for updating the software application to the treatment version of the software application.

23. The method of claim 21, wherein the software update for updating the software application includes code for updating the software application to the control version of the software application and code for updating the software application to the treatment version of the software application.

24. The method of claim 21, further comprising:
determining, by the one or more processors, whether the software application installed at a second computing device in the control group is the control version of the software application; and
responsive to determining that the software application installed at a second computing device is not the control version of the software application, sending, by the one or more processors to the second computing device, a second software update for updating the software application to the control version of the software application.

25. The method of claim 21, further comprising:
determining, by the one or more processors, the control version of the software application as one of: a version of the software application that is fully released to computing devices or a most recent version of the software application prior to the treatment version of the software application.

26. The method of claim 21, wherein sending the software update further comprises:
receiving, by the one or more processors and from the computing device, an auto update request associated with the software application; and
responsive to receiving the auto update request from the computing device, sending, by the one or more processors to the computing device, the software update to trigger the computing device to, in response to receiving the software update, reinstall the control version of the software application at the computing device from the storage device of the computing device.

27. The method of claim 21, wherein sending the software update to the computing device further triggers the computing device to store a copy of the treatment version of the software application in the storage device of the computing device, further comprising:
sending, by the one or more processors to the computing device, an indication that the treatment version of the software application is released as a next official version of the software application that causes the computing device to install the copy of the treatment version of the software application stored at the computing device to replace the control version of the software application.

28. A computing system comprising:
a memory that stores instructions; and
one or more processors that execute the instructions to:
determine that a software application installed at a computing device in a control group associated with a control-treatment experiment for the software application is a control version of the software application;
determine, based at least in part on the computing device being in the control group and the software application installed at the computing device being the control version of the software application, a software update for updating the software application to a treatment version of the software application that is to be sent to the computing device; and
send, to the computing device, the software update to trigger the computing device to, in response to receiving the software update, reinstall the control version of the software application at the computing device from a storage device of the computing device.

29. The computing system of claim 28, wherein the one or more processors are further configured to:
send, to a plurality of computing devices in a treatment group associated with the control-treatment experiment for the software application, the software update for updating the software application to the treatment version of the software application.

30. The computing system of claim 28, wherein the software update for updating the software application includes code for updating the software application to the control version of the software application and code for updating the software application to the treatment version of the software application.

31. The computing system of claim 28, wherein the one or more processors are further configured to:
determine whether the software application installed at a second computing device in the control group is the control version of the software application; and
responsive to determining that the software application installed at a second computing device is not the control version of the software application, send, to the second computing device, a second software update for updating the software application to the control version of the software application.

32. The computing system of claim 28, wherein the one or more processors are further configured to:
determine the control version of the software application as one of: a version of the software application that is fully released to computing devices or a most recent version of the software application prior to the treatment version of the software application.

33. The computing system of claim 28, wherein to send the software update, the one or more processors are further configured to:
receive, from the computing device, an auto update request associated with the software application; and
responsive to receiving the auto update request from the computing device, send, to the computing device, the software update to trigger the computing device to, in response to receiving the software update, reinstall the control version of the software application at the computing device from the storage device of the computing device.

34. The computing system of claim 28, wherein the software update being sent to the computing device further triggers the computing device to store a copy of the treatment version of the software application in the storage device of the computing device, and wherein the one or more processors are further configured to:
send, to the computing device, an indication that the treatment version of the software application is released as a next official version of the software application that causes the computing device to install the copy of the treatment version of the software application stored at the computing device to replace the control version of the software application.

35. A non-transitory computer-readable storage medium comprising instructions, that when executed by one or more processors of a computing system, cause the one or more processors to:
determine that a software application installed at a computing device in a control group associated with a control-treatment experiment for the software application is a control version of the software application;
determine, based at least in part on the computing device being in the control group and the software application installed at the computing device being the control version of the software application, a software update for updating the software application to a treatment version of the software application that is to be sent to the computing device; and
send, to the computing device, the software update to trigger the computing device to, in response to receiving the software update, reinstall the control version of the software application at the computing device from a storage device of the computing device.

36. The non-transitory computer-readable storage medium of claim 35, wherein the instructions further cause the one or more processors to:
send, to a plurality of computing devices in a treatment group associated with the control-treatment experiment for the software application, the software update for updating the software application to the treatment version of the software application.

37. The non-transitory computer-readable storage medium of claim 35, wherein the software update for updating the software application includes code for updating the software application to the control version of the software application and code for updating the software application to the treatment version of the software application.

38. The non-transitory computer-readable storage medium of claim 35, wherein the instructions further cause the one or more processors to:
determine whether the software application installed at a second computing device in the control group is the control version of the software application; and
responsive to determining that the software application installed at a second computing device is not the control version of the software application, send, to the second computing device, a second software update for updating the software application to the control version of the software application.

39. The non-transitory computer-readable storage medium of claim 35, wherein the instructions further cause the one or more processors to:
determine the control version of the software application as one of: a version of the software application that is fully released to computing devices or a most recent version of the software application prior to the treatment version of the software application.

40. The computing system of claim 35, wherein the instructions that cause the one or more processors to send the software update further cause the one or more processors to:
receive, from the computing device, an auto update request associated with the software application; and
responsive to receiving the auto update request from the computing device, send, to the computing device, the software update to trigger the computing device to, in response to receiving the software update, reinstall the control version of the software application at the computing device from the storage device of the computing device.
